(19) United States
(12) Patent Application Publication
(10) Pub. No.: US 2003/0224122 A1
(43) Pub. Date: Dec. 4, 2003

(54) Method of using a roll coater and method of modifying the same

(76) Inventor: Richard A. Lopez, Dana Point, CA (US)

Correspondence Address: Richard Lopez, 24683 Santa Clara Avenue, Dana Point, CA, 92629, US

(21) Appl. No.: 10/156,166

(22) Filed: May 28, 2002

(51) Int. Cl. B32B 31/00

(52) U.S. Cl. 427/428; 427/421; 156/278

(57) ABSTRACT

A method of fire-retarding a wood substrate includes providing a wood substrate; providing a roll coater for applying a fire-retardant layer to the wood substrate, the roll coater including one or more rollers; drawing the wood substrate through the roll coater; applying a fire-retardant layer on at least an upper surface of the wood substrate with one or more rollers; and removing the wood substrate from the roll coater.

### FIELD OF THE INVENTION

The invention relates, in general, to roll coating, and, in particular, to roll coating wood substrates for fire-retardant treatment.

### BACKGROUND OF THE INVENTION

Building codes and public safety concerns in metropolitan areas such as large cities are requiring non-structural, permanently installed wood products such as cabinets, doors, moldings, etc. to have fire-retardant properties. The basic components of many of these wood products include a wood substrate, an adhesive layer, and a veneer or laminae.

Weyerhaeuser Company of Federal Way, Wash. manufactures fire-retardant particle board sold under the tradename Duraflake FR that may be used as the substrate for wood products such as wood panels for cabinets (Duraflake FR was previously sold by Willamette Industries, Inc. of Albany, Oreg. before an acquisition of Willamette Industries, Inc. by Weyerhaeuser Company). Duraflake FR is a manufactured Class 1 fire-rated particle board, wherein a fire retardant is added to the slurry of wood fibers/particles and glue during manufacture of the particle board.

Problems with the Duraflake FR product include that it is expensive, and it does not solve the problem of fire retarding other types of particle board not manufactured to be fire retardant. In regard to the expense of the Duraflake FR product, not only is the product manufactured by a more complicated process than particle board that is not fire-retardant, adding to the expense, but the product is only manufactured in two locations: 1) the East coast, and 2) the West coast. Thus, expense layers of warehousing, trucking, and distribution of the Duraflake FR product adds to the cost of the product.

To fire retard particle board that was not manufactured to be fire retardant, the particle board must be separately chemically treated with a fire retardant at a treatment facility. This may involve shipping the particle board to a chemical treatment facility for fire retardant treatment and, from there, to a wood distributor. The particle board may then be shipped to a laminator where an adhesive and a laminate or veneer (e.g., wood layer, plastic layer) may be applied to make, for example, the basic components of a cabinet, door, molding, etc. The extensive shipping process of the particle board and the additional fire retarding process performed by a separate treatment facility adds cost to the fire-retarded particle board purchased by the laminator.

### SUMMARY OF THE INVENTION

The inventor of the present invention recognized that many laminators (approximately 4,000 in the United States) use a machine that applies an adhesive for lamination that, with slight modifications, may be used for applying a fire-retardant chemical to wood substrates such as particle board as well as a fire-retardant adhesive. As a result, laminators can fire retard particle board at their facility with the equipment they already have and are familiar with instead of having to buy expensive particle board manufactured for fire retardancy, or expensive particle board that was separately chemically treated for fire retardancy.

Another aspect of the invention involves a method of fire-retarding a wood substrate having an upper surface and a lower surface. The method includes providing a roll coater for applying a fire-retardant coating to the wood substrate, the roll coater including a roller assembly that draws the wood substrate therethrough and a variable-speed mechanism that varies the speed of the roller assembly, the roller assembly including upper rolls that apply a fire-retardant coating to the upper surface of the wood substrate, and one or more lower fluid emitting devices that directly apply a fire-retardant coating to the lower surface of the wood substrate; using the variable-speed mechanism to operate the roller assembly at a speed slower than the speed of the roller assembly without the variable-speed mechanism; feeding the wood substrate into the roll coater; applying the fire-retardant coating to the upper surface of the wood substrate with the upper rolls of the roller assembly; applying the fire-retardant coating directly to the lower surface of the wood substrate with the one or more lower fluid emitting devices; removing the fire-retarded wood substrate with fire-retardant coating from the roll coater; and drying the wood substrate.

A further aspect of the invention involves a method of fire-retarding a wood substrate having an upper surface and a lower surface. The method includes providing a wood substrate; providing a roll coater for applying a fire-retardant layer to the wood substrate, the roll coater including one or more rollers; drawing the wood substrate through the roll coater; applying a fire-retardant layer on at least the upper surface of the wood substrate with one or more rollers; and removing the wood substrate from the roll coater.

A still further aspect of the invention involves a method of modifying a roll coater for applying a fire-retardant coating to a wood substrate including an upper surface and a lower surface. The method includes providing a roll coater including a roller assembly that draws the wood substrate therethrough, the roller assembly including upper rolls to apply a fire-retardant coating to the upper surface of the wood substrate; adding one or more lower fluid emitting devices to the roll coater to directly apply a fire-retardant coating to the lower surface of the wood substrate so that the wood substrate is coated on both the upper surface and the lower surface; and providing a variable-speed mechanism to vary the speed of the roller assembly.

A yet further aspect of the invention involves a method of creating a fire-rated panel assembly. The method includes providing a wood panel, providing a fire-retardant coating on the wood panel; providing a fire-retardant adhesive on the wood panel; and providing a fire-retardant laminae on the wood panel over the adhesive. In an implementation of the invention, the steps of providing a fire-retardant coating on the wood panel and providing a fire-retardant adhesive on the wood panel is performed using a roll coater.

Further objects and advantages will be apparent to those skilled in the art after a review of the drawings and the detailed description of the preferred embodiments set forth below.

### BRIEF DESCRIPTION OF THE DRAWINGS

FIG. 1 is a perspective view of an embodiment of a roll coater and fluid supply and delivery system that may be used to apply a fire-retardant chemical and/or a fire-retardant adhesive to a wood substrate such as particle board.

FIG. 2 is a side view of the roll coater and fluid supply and delivery system illustrated in FIG. 1.

FIG. 3 is a simplified schematic of the rollers of the roll coater in FIG. 1 shown receiving a wood substrate.

### DETAILED DESCRIPTION OF PREFERRED EMBODIMENTS

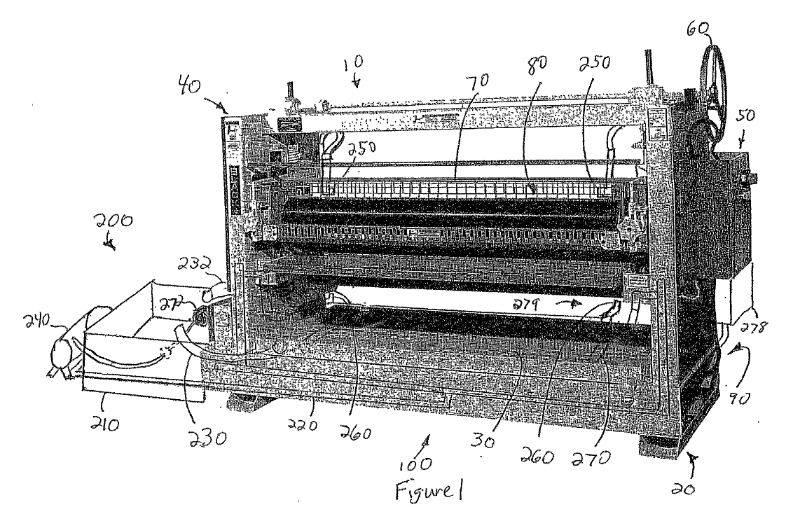

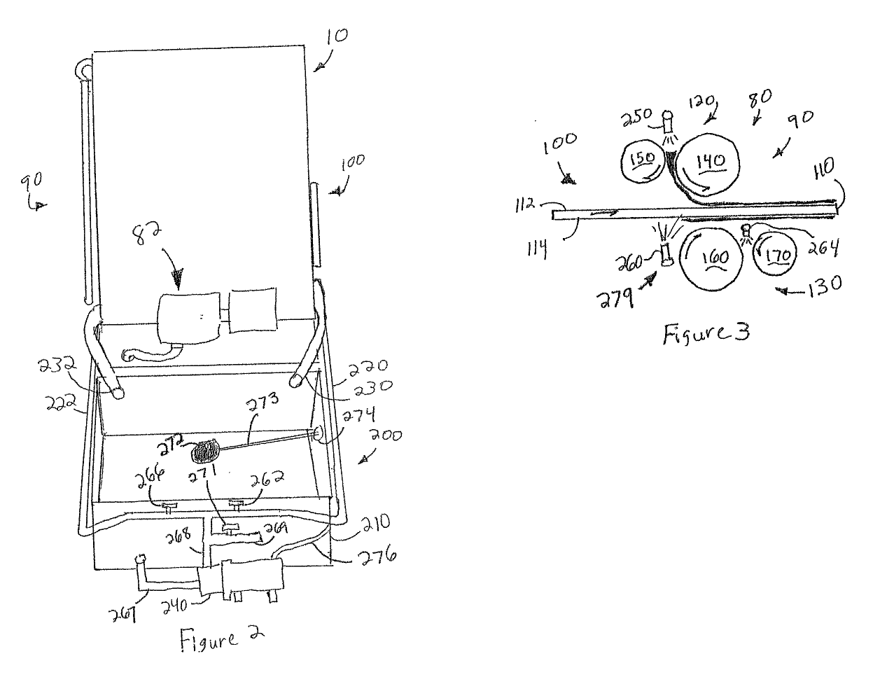

With reference to FIGS. 1-3, an embodiment of an adhesive spreader and roll coater 10 (hereinafter described as a “roll coater”) that may be used to apply a fire-retardant coating and/or a fire-retardant adhesive to a wood substrate such as particle board will now be described. As used herein, “wood substrate” includes any generally flat, wood-related product. Examples of wood substrates include, but not by way of limitation, particle board, medium-density fiberboard, modified density overlay, plywood, chip board, and oriented strand board. Although the roll coater 10 will be described as being used to apply a fire-retardant coating and a fire-retardant adhesive to a wood substrate, the roll coater 10 may also be used to apply either a fire-retardant coating or a fire-retardant adhesive to a wood substrate.

The roll coater 10 shown and described herein is a 775 Hot Melt Spreader sold by Black Bros. Co. of Mendota, Ill. However, other types of roll coaters may be used. The roll coater 10 generally includes a stand 20, a collection tray 30, a frame 40, a control unit 50, a roll adjustment handwheel 60, machine guards 70, and a roller assembly 80 having multiple rollers rotatably coupled to a motor 82. The roll coater 10 includes a front 90 and a rear 100.

A wood substrate 110 includes an upper surface 112 and a lower surface 114. In the embodiment of the wood substrate 110 shown, the wood substrate 110 is a particle board panel that is 4 ft. by 8 ft. and has a thickness of ¾ in.

The wood substrate 110 is received by a roller assembly 80, which includes upper rolls 120 and lower rolls 130. The upper rolls 120 include a main roll 140 and a secondary roll 150. The lower rolls 130 include a main roll 160 and a secondary roll 170.

A fluid supply and delivery system 200 may be used to supply one or more different types of fluids to the roll coater 10. The system 200 generally includes one or more fluid reservoirs 210, rear supply line 220, front supply line 222, rear return line 230, front return line 232, and a pump 240 for pumping fluid to and from the roll coater 10.

The rear supply line 220 includes one or more tubes, lines, couplings, or other connectors for delivering fluid to lower fluid emitting devices or nozzles 260. The lower nozzles 260 may be used to spray fluid directly on the lower surface 114 of the wood substrate 110. One or more support frames, brackets, or other supporting structures 270 may be used to support the lower nozzles 260 and/or rear support line 220. At one or more points in the rear supply line 220, one or more valves 262 may be used to control the amount of flow delivered.

The front supply line 222 includes one or more tubes, lines, couplings, or other connectors for delivering fluid to lower fluid emitting devices or nozzles 264 (FIG. 3) and upper fluid emitting devices or nozzles 250. The lower nozzles 264 supply fluid to the lower rollers 130 for roll coating the lower surface 114 of the wood substrate 110.

The upper nozzles 250 supply fluid to the upper rollers 120 for roll coating the upper surface 112 of the wood substrate 110. One or more support frames, brackets, or other supporting structures may be used to support the nozzles 250, 264 and/or front support line 222. At one or more points in the front supply line 222, one or more valves 266 may be used to control the amount of flow delivered.

A pump inlet line 267 is used to deliver fluid from the reservoir 210 to the pump 240. A delivery line 268 is used to deliver fluid from the pump 240 to the supply lines 220, 222. A connector line 269 may branch off of the delivery line 260. The connector line 269 connects the system 200 with a tote (not shown) of coating solution, usually 200 gallons of coating solution. The connector line 269 may include a valve 271 for controlling the amount of fluid transferred between the tote and the system 200.

The rear return line 230 and the front return line 232 are connected to the collection tray 30 for delivering fluid in the collection tray 30 to the reservoir 210.

Inside the reservoir 210, a float ball 272 may be used to prevent fluid overflow in the reservoir 210. A shaft 273 extending from the float ball 272 may be pivotally connected to an overflow mechanism 274. The overflow mechanism 274 is electrically connected to the pump 240 via a wire 276 for shutting off the pump 240 when the float ball 272 rises to a certain fluid level.

A variable-speed mechanism known as an electrical vari-drive 278 provides variable-speed control of the roller assembly 80. Variable-speed control of the roller assembly 80 is important for operating the roller assembly 80 at a slower speed during application of the lower-viscosity fire-retardant coating solution and for operating the roller assembly 80 at a faster speed during application of the higher-viscosity fire-retardant adhesive solution.

The roll coater 10 may be easily converted to a roll coater suitable for applying a fire-retardant coating solution to a wood substrate by simply adding the fluid supply and delivery system 200 and wiring the electrical vari-drive 278 between the control panel 50 and the motor 82.

A method of using the roll coater 10 to apply a fire-retardant coating and/or a fire-retardant adhesive to the wood substrate 110 will now be described.

A fire-retardant coating solution is added to the reservoir 210. This may be done, for example, by connecting a tote of fire-retardant coating solution to the connector line 269 and operating the pump 240 or by pouring or pumping the fire-retardant coating solution directly into the reservoir 210.

The motor 82 of the roll coater 10 is actuated and controlled through the control unit 50 and the electrical vari-drive 278. Actuation of the motor 82 causes the upper rolls 120 and the lower rolls 130 of the roller assembly 80 to rotate in the manner shown in FIG. 3. The electrical vari-drive 278 is used to control the speed of the motor 82 and, hence, the speed of the roller assembly 80. The roller assembly 80 is operated at a speed less than the normal operational speed of the roller assembly without the electrical vari-drive during application of the fire-retardant coating solution to the wood substrate 110. It is important to slow the roller assembly 80 down when applying the fire-retardant coating because the low-viscosity nature of the fire-retardant coating.

In addition to controlling the amount of fluid or fluid flow rate delivered to the wood substrate 110 by controlling the speed of the roller assembly 80 through the electrical vari-drive 278, the amount of fluid or fluid flow rate delivered to the wood substrate 110 may be controlled through the one or more valves 262, 266 or any other valves in the system 200. The valves may be opened, closed, or partially opened to control flow therethrough. The amount of fluid or fluid flow rate delivered to the wood substrate 110 may also be controlled through the roll adjustment handwheel 60. The roll adjustment handwheel 60 may be rotated to vary the distance between the rolls 140, 150, which, in turn, varies the amount of fluid or fluid flow rate delivered to the wood substrate 110.

The wood substrate 110 is advanced into the roller assembly 80 from the rear 100 of the roll coater 10 until the main rolls 140, 160 catch and draw the wood substrate 110 therethrough.

The pump 240 is activated to supply fire-retardant coating solution to the nozzles 250, 260, 264 through the supply lines 220, 222. Instead of, or in addition to, the pump 240, the fire-retardant solution may be supplied by one or more raised reservoirs 210 so that the force of gravity on the fluids causes fluid delivery to the roll coater 10.

The fire-retardant coating solution will now be described in more detail. The fire-retardant coating solution is a stable, non-corrosive preservative composition that imparts fire, insect, and fungus resistance qualities to the wood substrate. The fire-retardant coating solution is an aqueous solution of a boron-source composition selected from the group consisting of boric acid and the water-soluble salts thereof, a melamine binder resin, and a urea casein activator resin. The amount of the boron source composition, melamine binder resin, and urea casein activator resin are adjusted so that the resultant preservative composition has a weight ration of boron source to melamine ranging from 1.30:1 to 9.6:1, preferably about 8:1, and a weight ration of urea casein activator resin to melamine binder resin ranging from 1:20 to 1:4, preferably about 5.5:1.

The boron-source composition can be boric acid or the water-soluble salts of boric acid, including sodium tetraborate decahydrate, sodium tetraborate pentahydrate, sodium octaborate tetrahydrate, sodium metaborates, sodium perborate hydrates, 1 potassium tetraborate, sodium pentaborate, ammonium pentaborate hydrate, and hydrasodium tetraborate, potassium metaborate, any alkali metal borate salt, or combinations of these compounds. Preferably, the boron source composition is disodium octaborate tetrahydrate, which is commercially available from IMC Chemical, Overland Park, Kans. or U.S. Borax, Inc., Valencia, Calif. The boron-source compound is a primary fire retardant, as well as an insecticidal and fungicidal agent.

The melamine binder resin can be any amino resin made from melamine (2,4,6-triamino symtriazine) and formaldehyde, typically used for marine graded plywood, or as a nitrogen source in binders used to make pipe insulation. The melamine binder resin is characterized by a viscosity (@ 78° F.) ranging from 600-1000, a pH ranging from 8.6-9.7, a free formaldehyde concentration less than 0.5% by weight, a specific gravity of about 1.2, and a degree of polymerization of about 2.1. The melamine-binder resin acts as a nitrogen-liberating compound, releasing nitrogen in the presence of a flame. The melamine binder resin includes modified melamine-formaldehyde resins such as GP® 482T23 Thermal Insulation Binder Resin or GP® 476T19 Melamine Insulation Resin, both commercially available from Georgia-Pacific Resins, Inc, Dekatur, Ga., or MB 46-50 Liquid Melamine Adhesive commercially available from National Casein or Cytek, located in Santa Ana, Calif., and Jersey City, N.J., respectively. Preferably, the melamine binder resin is a liquid.

The urea casein activator resin can be any liquid urea formaldehyde resin typically used for marine or N graded plywood. The casein resin activator is characterized by a viscosity (@ 78° F.) of about 550 cp, solids percentage of 63%-67%, a pH of about 7.5, a specific gravity ranging from 1.20-1.38, and a formaldehyde concentration less than 1.5%. The urea casein activator resin is also nitrogen-liberating compound, which releases nitrogen in the presence of a flame. Preferably, the urea casein activator resin is #750 Urea Resin Adhesive or GP® 1967, commercially available from National Casein, Santa Ana, Calif. and Ga. Pacific Resins, Decatur, Ga., respectively.

After application to the treated wood products, the urea casein activator resin initiates a polymerization reaction involving the melamine binder resin. The resulting melamine polymer creates a substantially impervious barrier to atmospheric moisture and also binds or encapsulates the wood preservative composition to the treated wood product to prevent leaching of the boron source composition from the treated wood product through solubalization by atmospheric moisture. The melamine polymer acts as a nitrogen-liberating compound, which releases nitrogen in the presence of a flame.

The fire-retardant coating solution may be prepared by mixing one or more of the boron source compositions, the melamine binder resin, and the urea casein activator resin in an aqueous solution. The boron source compositions may first be dissolved in water and then mixed with the melamine binder resin and the urea casein activator resin, in that order. The melamine binder resin and urea casein activator resin may be each individually mixed in water before addition to the other ingredients of the preservative composition. This allows the proper buffering effect to occur. Generally, the urea casein activator resin is added last. The preservative composition may also be formed by first combining the melamine binder resin and the urea casein activator resin with water to form an aqueous solution. The aqueous solution of the melamine binder urea casein resin activator may then be added to an aqueous solution of the boron source composition. Alternatively, the preservative composition may be formed in a step process within the wood products themselves by first applying the boron-source composition and then applying an aqueous solution comprising the melamine binder resin and the urea casein activator resin.

Further information on the preferred fire-retardant coating solution used with the roll coater and method of making the same is described in U.S. application Ser. No. 09/615,259, entitled “FIRE RETARDANT COMPOSITIONS AND METHODS FOR PRESERVING WOOD PRODUCTS”, filed Jul. 13, 2002, which is incorporated by reference herein as though set forth in full.

The upper nozzles 250 and lower nozzles 264 supply fire-retardant coating solution to the upper rolls 120 and lower rolls 130, respectively, which in turn apply the fire-retardant coating solution to the upper surface 112 and the lower surface 114 of the wood substrate 110.

When applying the fire-retardant coating solution to the wood substrate 110, the lower nozzles 260 are used to spray the fire-retardant coating directly on the lower surface 114 of the wood substrate 110 in addition to or instead of using the lower nozzles 264 to apply the fire-retardant coating on the lower surface 114 of the wood substrate 110. In a preferred embodiment, the lower nozzles 260 are used instead of the lower nozzles 264 to apply the fire-retardant coating to the lower surface 114 of the wood substrate 110. If the lower nozzles 260 are used instead of the lower nozzles 264, one or more valves controlling flow to the lower nozzles 264 may be closed. The inventor determined that applying the fire-retardant coating to the lower surface 114 of the wood substrate 110 using the lower rolls 130 alone does not sufficiently coat the lower surface 114 due to the low-viscosity of the fire-retardant coating.

After the wood substrate 110 is coated with the fire-retardant coating, the wood substrate 110 is removed from the roll coater 10 and dried in any well-known manner (e.g., drying kiln, air dried, microwave dried).

The collection tray 30 collects any fire-retardant coating solution that is not applied and retained by the wood substrate 110. The fire-retardant coating solution flows from the collection tray 30, through the return lines 230, 232, and back into the reservoir 210, for recirculation.

The float ball 272 is used to prevent fluid overflow in the reservoir 210. If the fluid level in the reservoir 210 gets too high, the float ball will rise to a level that, through the shaft 273, causes the overflow mechanism 274 to shut off the pump 240, preventing additional fire-retardant coating solution from being added to the reservoir 210.

In addition to the fire-retardant coating, or as an alternative to the fire-retardant coating, a fire-retardant adhesive may be applied to the upper surface 112 and/or lower surface 114 of the wood substrate 110. The method of applying the fire-retardant adhesive to the wood substrate 110 is generally the same as the method described above, so only the general differences from the method described above will be described for the method of applying the fire-retardant adhesive. The main differences with the method of applying the fire-retardant adhesive are: 1) the speed of the roller assembly 80 is increased with the electrical-vari drive 278 because the viscosity of the fire-retardant adhesive solution is higher than that of the fire-retardant coating solution, 2) the lower nozzles 260 are not used to directly apply the adhesive to the lower surface 114 of the wood substrate 110, and 3) the lower nozzles 264 may not be used to apply the adhesive to the lower surface 114 of the wood substrate 110 via the lower rolls 130 if lamination is only going to occur on the upper surface 112.

Before applying the fire-retardant adhesive, if the fire-retardant coating was previously applied using the roll coater 10, any extra fire-retardant coating may be pumped from the reservoir 210, through the connector line 269, and into a fire-retardant coating solution tote. A separate tote including fire-retardant adhesive solution may be hooked up to the connector line 269 and transferred into the reservoir 210. The fire-retardant adhesive solution may also be poured into the reservoir 210.

In a preferred embodiment, the main difference between the fire-retardant coating solution and the fire-retardant adhesive solution is that the amount of water used in the fire-retardant adhesive solution is 60-90% less than the amount of water used in the fire-retardant coating solution. In a more preferred embodiment, the amount of water used in the fire-retardant adhesive solution is approximately 80% less than the amount of water used in the fire-retardant coating solution. Accordingly, the fire-retardant adhesive is more viscous and has a higher specific gravity than the fire-retardant coating solution.

After the wood substrate 110 is coated with the fire-retardant adhesive, a laminae or veneer is applied to the wood substrate 110 over the fire-retardant adhesive.

This new use of a roll coater to apply a fire-retardant coating to a wood substrate allows laminators to fire-retard wood substrates such as particle board with a machine many laminators already have, eliminating the need to purchase expensive particle board that is manufactured to be fire retardant (e.g., Duraflake FR) or particle board that must be separately treated for fire retardancy by a separate treatment facility. The resulting savings may be passed onto customers (e.g., cabinet makers, door makers, molding manufacturers) and/or laminators may realize an additional layer of profitability because the laminators fire retard the panels, not the panel manufacturer and not a separate treatment facility. It is estimated that the laminator's cost per panel for a standard Duraflake FR panel (4 ft. by 8 ft. % in. thick), which is manufactured to be fire retardant, is presently estimated at approximately $30-35. Because the Duraflake FR panel is only being manufactured by one company at two locations, one on the East coast and one on the West coast, much of the expense of the Duraflake FR panel is from the additional cost layers of warehousing, trucking, and distribution. In contrast, the process of the present invention may be performed at the laminator's facility, where the necessary equipment (i.e., roll coater) already exists. As a result, the cost to the laminator per panel for a fire-rated panel using the process of the present invention is presently estimated at approximately $20-25, resulting in a significant cost savings to the laminator for fire-rated panels.

Because of the relatively small size of roll coaters such as the roll coater 10 described herein, the process of the present invention may be performed at locations other than a lamination facility. For example, but not by way of limitation, the process may be performed at a distributor, at a manufacturer of the wood substrate, and at a job site.

The present invention also allows the laminator to produce a fire-retardant panel assembly because the wood substrate is fire retarded by the laminator, the adhesive added by the laminator is fire-retardant, and the laminae or veneer may be plastic or another fire-retardant material.

It will be readily apparent to those skilled in the art that still further changes and modifications in the actual concepts described herein can readily be made without departing from the spirit and scope of the invention as defined by the following claims.

What is claimed is:

1. A method of fire-retarding a wood substrate having an upper surface and a lower surface, comprising:
providing a wood substrate;
providing a roll coater for applying a fire-retardant coating to the wood substrate, the roll coater including a roller assembly that draws the wood substrate therethrough and a variable-speed mechanism that varies the speed of the roller assembly, the roller assembly including at least upper rolls that apply a fire-retardant coating to the upper surface of the wood substrate, and one or more lower fluid emitting devices that apply a fire-retardant coating directly to the lower surface of the wood substrate;
using the variable-speed mechanism to operate the roller assembly at a speed slower than the speed of the roller assembly without the variable-speed mechanism;
feeding the wood substrate into the roller assembly;
applying the fire-retardant coating to the upper surface of the wood substrate with the upper rolls of the roller assembly;
applying the fire-retardant coating directly to the lower surface of the wood substrate with the one or more lower fluid emitting devices;
removing the fire-retarded wood substrate from the roll coater;
drying the fire-retarded wood substrate.

2. The method of claim 1, wherein the roller assembly includes upper rolls having a main roll and a secondary roll and lower rolls having a main roll and a secondary roll, and the step of applying the fire-retardant coating to the lower surface of the wood substrate with the one or more fluid emitting devices is performed without applying the fire-retardant coating with the lower rolls.

3. The method of claim 1, wherein the wood substrate is a member from the group consisting of particle board, medium-density fiberboard, modified density overlay, plywood, chip board, and oriented strand board

4. The method of claim 1, wherein the fire-retardant coating is a fire-retardant solution.

5. The method of claim 4, wherein the fire-retardant solution of the fire-retardant coating is water soluble.

6. The method of claim 4, wherein the fire-retardant solution includes a boron-source composition selected from the group consisting of boric acid and the water-soluble salts thereof, a melamine binder resin, and an urea casein activator resin.

7. The method of claim 1, further including using the variable-speed mechanism to operate the roller assembly at a speed faster than the speed of the roller assembly during application of the fire-retardant coating, feeding the fire-retarded wood substrate into the roll coater; applying a fire-retardant adhesive to at least the upper surface of the fire-retarded wood substrate with the upper rolls of the roller assembly; and removing the fire-retarded wood substrate with fire-retardant adhesive from the roll coater.

8. The method of claim 7, wherein the roller assembly also includes lower rolls, and applying a fire-retardant adhesive also includes applying a fire-retardant adhesive to the lower surface of the fire-retarded wood substrate with the lower rolls of the roller assembly.

9. The method of claim 7, wherein the fire-retardant adhesive is water soluble.

10. The method of claim 7, wherein the fire retardant adhesive includes an amount of water that is 60-90% less than an amount of water used in the fire-retardant coating.

11. The method of claim 7, further including laminating the wood substrate on the fire-retardant adhesive with a laminae.

12. A method of fire-retarding a wood substrate having an upper surface and a lower surface, comprising:
providing a wood substrate;
providing a roll coater for applying a fire-retardant layer to the wood substrate, the roll coater including one or more rollers;
drawing the wood substrate through the roll coater;
applying a fire-retardant layer on at least the upper surface of the wood substrate with one or more rollers;
removing the wood substrate from the roll coater.

13. The method of claim 12, wherein the fire-retardant layer is a fire retardant coating.

14. The method of claim 12, wherein the fire-retardant layer is a fire retardant adhesive.

15. The method of claim 12, wherein the wood substrate is a member from the group consisting of particle board, medium-density fiberboard, modified density overlay, plywood, chip board, and oriented strand board.

16. The method of claim 12, wherein the fire retardant layer is a fire-retardant solution including an aqueous solution of a boron-source composition selected from the group consisting of boric acid and the water-soluble salts thereof, a melamine binder resin, and an urea casein activator resin.

17. The method of claim 12, wherein applying a fire-retardant layer includes applying a fire-retardant layer on the upper surface of the wood substrate with one or more rollers and applying a fire-retardant layer on the lower surface of the wood substrate.

18. The method of claim 17, wherein applying a fire-retardant layer to the lower surface of the wood substrate is performed by at least one of 1) directly spraying a fire-retardant layer on the lower surface of the wood substrate with one or more lower fluid emitting devices, and 2) applying a fire-retardant layer on the lower surface of the wood substrate with lower rolls.

19. The method of claim 12, wherein the fire-retardant layer is a fire-retardant coating solution, and the method further includes using a variable-speed mechanism to operate the roller assembly at a speed slower than the speed of the roller assembly without the variable-speed mechanism when applying the fire-retardant coating solution.

20. The method of claim 19, further including using the variable-speed mechanism to operate the roller assembly at a speed faster than the speed of the roller assembly during application of the fire-retardant coating solution after applying the fire-retardant coating solution to the wood substrate, feeding the fire-retarded wood substrate a second time into the roll coater; applying a fire-retardant adhesive to at least the upper surface of the fire-retarded wood substrate with one or more rollers; removing the fire-retarded wood substrate with fire-retardant adhesive from the roll coater.

21. The method of claim 20, further including laminating the wood substrate on the fire-retardant adhesive with a laminae.

22. The method of claim 12, wherein the fire-retardant layer is a fire-retardant coating, and the method further includes applying a fire retardant adhesive to the wood substrate, the fire-retardant adhesive including an amount of water that is 60-90% less than an amount of water used in the fire-retardant coating.

23. A method of modifying a roll coater for applying a fire-retardant coating to a wood substrate including an upper surface and a lower surface, comprising:
providing a roll coater including a roller assembly that draws the wood substrate therethrough, the roller assembly including at least upper rolls to apply a fire-retardant coating to the upper surface of the wood substrate;
adding one or more lower fluid emitting devices to the roll coater to directly apply a fire-retardant coating to the lower surface of the wood substrate so that the wood substrate is coated on both the upper surface and the lower surface; and
providing a variable-speed mechanism to vary the speed of the roller assembly.
